(19) United States
(12) Patent Application Publication
(10) Pub. No.: US 2018/0369944 A1
(43) Pub. Date: Dec. 27, 2018

(54) Method of cutting openings in flat, concave, converging, and convex surfaces, and welding flat, concave, converging, and convex surfaces of a workpiece

(71) Applicant: Promotech sp. z o.o., Bialystok (PL)

(72) Inventors: Krzysztof FEDYK, Bialystok (PL); Marcin LIZEWSKI, Bialystok (PL); Marcin FEDYK, Bialystok (PL); Miroslaw Tadeusz PAJOR, Bezrzecze (PL); Kamil STATECZNY, Swinoujscie (PL); Marek GRUDZINSKI, Mierzyn (PL); Pawel Wojciech HERBIN, Debno (PL)

(73) Assignee: Promotech sp. z o.o., Bialystok (PL)

(21) Appl. No.: 15/634,395

(22) Filed: Jun. 27, 2017

(51) Int. Cl. B23K 7/10; B23K 3/08

(52) U.S. Cl. CPC B23K 7/102; B23K 3/08

(57) ABSTRACT

A method of cutting openings in flat, concave, convex, and converging surfaces, in which the geometry of the outline of the element to be welded into the workpiece is measured, while subsequently an electronic control unit of the device uses the measurement data to plot the path of the cutting tool, and the IMCM device is placed onto the work surface, where the geometry of the work surface is measured using a scanning system, cutting parameters are automatically entered into the control unit based on the measurement results, the surface is heated and cut along the selected path, the cut-out part of the surface is removed, and the edges of the cut-out opening are grinded.

### DESCRIPTION OF THE INVENTION

The subject of the invention is a method of cutting openings in flat, concave, converging, and convex surfaces, and welding flat, concave, converging, and convex surfaces of a workpiece. Although these methods can be used in a variety of applications, they are particularly useful in the construction of wind turbine towers for which it is necessary to cut openings in their concave surfaces, e.g. inside the pipes that constitute tower sections.

The state of the art knows various methods of cutting openings in surfaces. The methods relating to the preparation of wind turbine tower components are relevant for the subject of the invention. Publication WO2006050723 discloses a method for manufacturing a wind turbine tower part, where the part comprises at least one wall segment and at least one segment with an opening. These parts are manufactured as separate, and subsequently assembled to form a ring. The part with an opening is made separately by torch cutting the piece and subsequent rolling. The state of the art does not disclose any devices for cutting openings in pipe elements, and in already installed elements. Also, no methods or devices are disclosed for cutting openings in vertical, horizontal, and diagonal elements alike.

The description of international patent application WO2011133050A1 discloses a method and device for cutting openings in flat, concave, and convex surfaces, which specifies a device and method for the measurement of workpieces, machine installation procedure, installation of operating modules, and the cutting process with the use of the machine, in particular cutting openings for door frames in wind turbine tower structures. The method of cutting according to the invention is characterized in that:
distinctive points of the outline of the opening to be cut are measured;
the parameters of the opening to be cut are entered into an electronic control unit of the device;
an axis or axes of the opening to be cut are identified on the work surface;
the opening cutting device is placed onto the work surface;
the position of the opening cutting device relative to the work surface is determined using laser pointers that indicate the center of the device and the line that represents the axis of the opening;
central grips and corner grips on the work surface are locked;
a cutting module is placed at the extreme position of the opening to be cut;
the shape of the opening is chosen, or the cutting path is calculated on the basis of the saved measurement values;
cutting parameters are entered into the control unit;
the surface is heated and cut along the selected path;
the cut-out part of the surface is removed;
the

edges of the cut-out opening are grinded. A drawback of this solution is that all the measurements are required to be made manually, and the results need to be entered into the machine controller; the shape of the convex or concave part is determined indirectly by measuring its distinctive points, which introduces considerable errors in calculating the path for the tool. This solution also prevents automatic adjustment of the path at local deformations that occur in particular during thermal cutting.

The aim of the invention is to develop a method and operating elements for faster and more accurate measurement, calibration, and operation of such a machine. The solution used in the machine enables direct measurement of the shape of the element to be cut, and measurement of the shape of the element inserted in the opening, e.g. a door frame. A more accurate measurement of the shape geometry, and a tracking system for the path of a joint reduces the duration of cutting and welding operations, and improves the quality of the cut and subsequent welding, reducing the number of welding defects in the joint.

Vision scanning systems are necessary due to several factors and due to the inherent characteristics of the technological operations, the examples of which are provided in the previous paragraph. One of the main challenges involves the deformations of the steel material due to heating. The original shape of the surface may deform due to the occurrence or release of strain in the base material or the welds. Also deformations that arise due to local structural weakness after cutting out an opening need to be considered. Depending on the place of support of a structure and the distribution of its weight, the metal sheet in the vicinity of the opening may lower or rise due to gravity. These factors mostly affect the vertical axis (Z coordinate of the Cartesian coordinate system).

The method of cutting openings in flat, concave, convex, and converging surfaces, in which the geometry of the outline of the element to be welded into the workpiece is measured, while subsequently an electronic control unit of the device uses the measurement data to plot the path of the cutting tool, and the IMCM device is placed onto the work surface, according to the invention is characterized in that:
1) the geometry of the work surface is measured using a scanning system;
2) cutting parameters are automatically entered into the control unit based on the measurement results;
3) the surface is heated and cut along the selected path;
4) the cut-out part of the surface is removed;
5) the edges of the cut-out opening are grinded.

Preferably, the scanning system carries out measurements using machine vision system or laser beams so as to measure the distance from the workpiece to the sensor.

Preferably, after cutting the opening out, before commencing the next work processes, a subsequent measurement of the work surface geometry is made.

Preferably, if, in the course of the process, there is a deviation from the established path of the tool movement, the path of the tool movement is adjusted in the tool axis and/or in the plane perpendicular to the tool axis in a direction normal to the edge of the cut workpiece.

In another aspect, the subject of the invention is the method of welding flat, concave, convex, and converging surfaces of a workpiece, in which the geometry of the outline of the element to be welded into the workpiece is measured, while subsequently an electronic control unit of the device uses the measurement data to plot the path of the welding tool, and subsequently the IMCM device is placed onto the work surface, characterized in that:
1) the geometry of the work surface is measured using a scanning system;
2) welding parameters are automatically entered into the control unit based on the measurement results;
3) the position of the tip of the welding tool relative to the workpiece is identified, in particular in relation of the frame and the weld joint;
4 ) the workpiece is heated and welded along the established path.

Preferably, the scanning system carries out measurements using machine vision system or laser beams so as to measure the distance from the workpiece to the sensor.

Preferably, the welding process is accompanied with real-time tracking of the welding path.

Preferably, if, in the course of the process, there is a deviation from the established path of the tool movement, the path of the tool movement is adjusted in the tool axis and/or in the plane perpendicular to the tool axis in a direction normal to the edge of the welded workpiece.

The nature of the device used in the methods according to the invention is that it is equipped with a scanning head comprising a projector module, which projects onto the workpiece a structural image consisting of programmed patterns. This image is then recorded by two video cameras calibrated relative to the system, and the data are processed by a PC or a calculation unit of the machine. The cloud of points obtained in this way is then converted with the use of mathematical algorithms into a model of a solid object representing the workpiece, its shape, and the position of the main axes relative to the machine. This enables, in the course of cutting, the adjustment of the position of the head to maintain constant distance from the material taking into account its actual shape.

The second variant of operation, as an option for direct assistance of the process of welding in a door frame, involves scanning the cut-out opening to determine the deformations due to local strain recovery. As deformations may be significant to the extent preventing proper welding, adjustments are made in the movement of the welding head based on the scanned opening edge. The scanning process is carried out in the same manner as in the previous step. An additional algorithm is also applied for the detection of the inner edge of the opening, and the triple-coordinate data are provided, after processing, to the main controller of the axis of the IMCM machine.

It is preferable for the scanning system to be easily detachable from the IMCM machine, which is important for the durability of the system and the correctness of downstream operations, i.e. cutting, welding, etc.

It is preferable for the machine to be equipped with a system of manipulators for manual control of all axes to move the working tool to any position without the use of the main control panel. The operation of a manipulator enables complex movement of several axes, therefore reducing the time required to set the machine in place before the commencement of the process. Locating manipulators next to the tool improves the ergonomics and movement precision, in particular for rotating axes.

The welded joint real-time tracking system allows the user to control any deviations of the actual path of the welded joint from the path established in the control system. Real-time welding path tracking systems are necessary mostly due to the action of heat transmitted into the material during the welding process. As heated steel expands, it distorts the original geometry of the structure, which necessitates the adjustment of the torch position. Another issue relates to the arrangement errors of the welded pieces. Additionally, in multi-pass welding it is necessary to adjust the position of the torch tip relative to the actual position of the filler metal applied in the previous pass. The tracking system consists of the sensors that track the actual position, whereas one sensor moves horizontally and the other moves vertically relative to the welding path and the path of the measurement system controller.

The subject of the invention is shown as an embodiment in figures, in which:

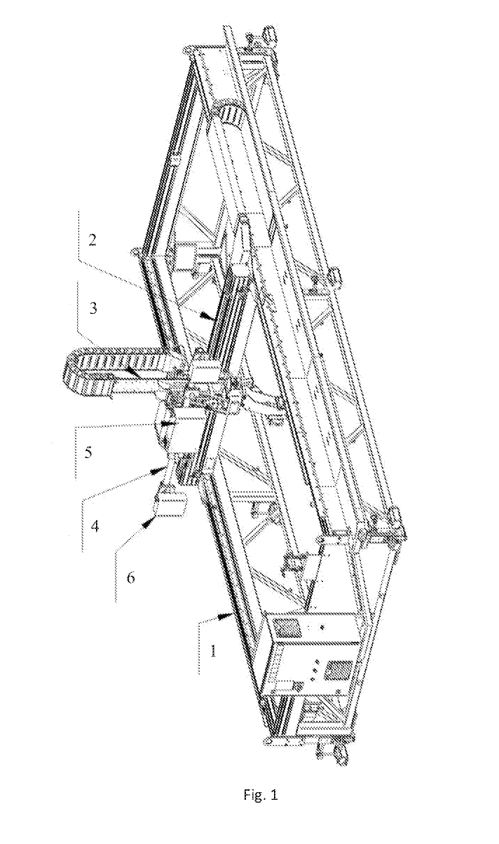

FIG. 1 is a device for the implementation of the method in axonometric projection.

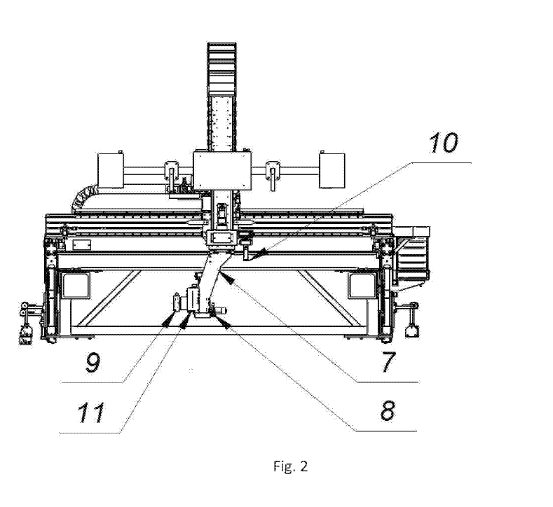

FIG. 2 is the device in front view.

The support frame (1) of the machine, to which X-axis travel guides are attached, on which an Y-axis bottom bracket (2) moves, and on the guides installed on it a Z-axis system (3) moves, onto which the scanning system (4) is installed, which consists of a projector (5) and a camera system (6). The system (3) is equipped with a swivel bottom bracket (7) of the tool head, whereas the bottom bracket (7) includes a tool head swinging chuck (8) for the installation of various types of heads, e.g. for cutting or welding. Rotary axis manipulator systems are installed on the bottom bracket (7), and tracking system sensors are installed directly on the welding head. The bottom bracket (7) of the tool head is equipped with manipulators (9) for manual control of the rotary axes, and a manipulator (10) for control of the linear movements of the machine is installed on a Z-axis system (3) component. The bottom bracket (7) of the tool head is equipped with an alternative scanning system solution comprising a laser distance sensor (11).

This implements the method of cutting openings in flat, concave, convex, and converging surfaces, in which the geometry of the outline of the element to be welded into the workpiece is measured. Subsequently, the electronic control unit of the device uses the measurement data to plot the path of the cutting tool. Then, the IMCM device is placed on the surface. Then, the following steps are carried out:
1. the geometry of the work surface is measured using a scanning system;
2. cutting parameters are automatically entered into the control unit based on the measurement results;
3. the surface is heated and cut along the selected path;
4. the cut-out part of the surface is removed;
5. the edges of the cut-out opening are grinded.

Additionally, the scanning system carries out measurements using machine vision system (4) or laser beams so as to measure the distance from the workpiece to the sensor (11). After cutting the opening out, before commencing the next work processes, a subsequent measurement of the work surface geometry is made. Preferably, if there is a deviation from the established path of the tool movement, the path of the tool movement is adjusted in the tool axis and/or in the plane perpendicular to the tool axis in a direction normal to the edge of the cut workpiece. Whereas, in the method of welding flat, concave, convex, and converging surfaces of a workpiece in which the geometry of the outline of the element to be welded into the workpiece is measured, while subsequently an electronic control unit of the device uses the measurement data to plot the path of the welding tool, and subsequently the IMCM device is placed onto the work surface. Then, the following steps are carried out:
1. the geometry of the work surface is measured using a scanning system;
2. welding parameters are automatically entered into the control unit based on the measurement results;
3. the position of the tip of the welding tool relative to the workpiece is identified, in particular in relation of the frame and the weld joint;
4. the workpiece is heated and welded along the established path.

Additionally, the scanning system carries out measurements using machine vision system (4) or laser beams so as to measure the distance from the workpiece to the sensor (11). The welding process is accompanied with real-time tracking of the welding path. Preferably, if there is a deviation from the established path of the tool movement, the path of the tool movement is adjusted in the tool axis and/or in the plane perpendicular to the tool axis in a direction normal to the edge of the welded workpiece.

1. The method of cutting openings in flat, concave, convex, and converging surfaces, in which the geometry of the outline of the element to be welded into the workpiece is measured, while subsequently an electronic control unit of the device uses the measurement data to plot the path of the cutting tool, and the IMCM device is placed onto the work surface, characterized in that:
1) the geometry of the work surface is measured using a scanning system;
2) cutting parameters are automatically entered into the control unit based on the measurement results;
3) the surface is heated and cut along the selected path;
4) the cut-out part of the surface is removed;
5) the edges of the cut-out opening are grinded.

2. A method according to claim 1, characterized in that the scanning system carries out measurements using machine vision system (4) or laser beams so as to measure the distance from the workpiece to the sensor (11).

3. A method according to claim 1, characterized in that after cutting the opening out, before commencing the next work processes, a subsequent measurement of the work surface geometry is made.

4. A method according to claim 1, characterized in that if there is a deviation from the established path of the tool movement, the path of the tool movement is adjusted in the tool axis and/or in the plane perpendicular to the tool axis in a direction normal to the edge of the cut workpiece.

5. The method of welding flat, concave, convex, and converging surfaces of a workpiece, in which the geometry of the outline of the element to be welded into the workpiece is measured, while subsequently an electronic control unit of the device uses the measurement data to plot the path of the welding tool, and the IMCM device is placed onto the work surface, characterized in that:
1) the geometry of the work surface is measured using a scanning system;
2) welding parameters are automatically entered into the control unit based on the measurement results;
3) the position of the tip of the welding tool relative to the workpiece is identified, in particular in relation of the frame and the weld joint;
4) the workpiece is heated and welded along the established path.

6. A method according to claim 5, characterized in that the scanning system carries out measurements using machine vision system (4) or laser beams so as to measure the distance from the workpiece to the sensor (11).

7. A method according to claim 5, characterized in that the welding process is accompanied with real-time tracking of the welding path.

8. A method according to claim 5, characterized in that if there is a deviation from the established path of the tool movement, the path of the tool is movement is adjusted in the tool axis and/or in the plane perpendicular to the tool axis in a direction normal to the edge of the cut workpiece.
